(19) United States
(12) Patent Application Publication
(10) Pub. No.: US 2010/0225561 A1
(43) Pub. Date: Sep. 9, 2010

(54) ELECTRICAL CONNECTOR WITH A TELEVISION SIGNAL RECEIVING FUNCTION

(75) Inventor: Tseng-Chieh Lee, Taipei (TW)

Correspondence Address: KILE GOEKJIAN REED & MCMANUS, 1200 NEW HAMPSHIRE AVE, NW, SUITE 570, WASHINGTON, DC, 20036, US

(73) Assignee: AZUREWAVE TECHNOLOGIES, INC.

(21) Appl. No.: 12/397,459

(22) Filed: Mar. 4, 2009

(51) Int. Cl. H01Q 1/50

(52) U.S. Cl. 343/906

(57) ABSTRACT

An electrical connector with a television signal receiving function includes a PCB module, a television signal receiving module, an antenna module, an electrical connector plug and an electrical connector casing. The television signal receiving module is electrically disposed on the PCB module. One end of the antenna module electrically is fixed on the PCB module, and the antenna module has an antenna unit disposed at its other end. One end of the electrical connector plug is electrically fixed on the PCB module, and the electrical connector plug has a plug body disposed at its other end. The electrical connector casing encloses the whole PCB module, the whole television signal receiving module, the end of the antenna module in order to expose the antenna unit, and the end of the electrical connector plug in order to expose the plug body.

### BACKGROUND OF THE INVENTION

1. Field of the Invention

The present invention relates to an electrical connector, and particularly relates to an electrical connector with a television signal receiving function.

2. Description of Related Art

Digital TV is a relatively new technology, and its texts and images are digital, that is coded in zeros and ones, as is the data in computers. Hence, the user can store and adjust frame and information that user wants. Noise is reduced and the sound and picture quality is better (similar to DVD) due to digital transmission. Originally one TV station can provide one channel; now one TV station can provide three or four different channels due to the image compression technology.

With the starting broadcasting successively of global digital television channel, various countries classify this as one of the important development projects invariably, and in a situation that the television of the general family is mostly analogue TV at present, in order to receiving digital TV signal without extra buying digital television, the most simple and most convenient way is to additionally install a Digital STB (Digital Set-Top Box) on traditional analogue TV in order to expand the TV function, is regarded as and connected the TV signal of the digit and connection bridge of the analogue TV. Hence, the Digital STB would be a bridge between the digital TV signal and the traditional analogue TV

And with the popularization day by day of the computer, consumers watching the digital TV not only can use the television, but also can use the computer in the family. At present, the computer can receive digital TV signal by using built-in digital TV receiving device or external digital TV receiving device (such as digital TV card). However, the computer using above-mentioned way only can receive FTA (Free-to-Air) signal. In addition, the user also can obtain more serves by using CA (Conditional Access), for example E-commerce serve, VOD (Video-on Demand) serve, on-line game serve, PPV (Pay Per View) serve, and individual value-added serve etc.

### SUMMARY OF THE INVENTION

One particular aspect of the present invention is to provide an electrical connector with a television signal receiving function. The structure of the present invention is simple. In addition, the electrical connector is integrated so that the present invention is light and handy and can be carried around conveniently for user. Therefore, the present invention does not need to be detached and assembled in using or carrying.

In order to achieve the above-mentioned aspects, the present invention provides an electrical connector with a television signal receiving function, including: a PCB module, a television signal receiving module, an antenna module, an electrical connector plug and an electrical connector casing. The television signal receiving module is electrically disposed on the PCB module. One end of the antenna module electrically is fixed on the PCB module, and the antenna module has an antenna unit disposed at its other end. One end of the electrical connector plug is electrically fixed on the PCB module, and the electrical connector plug has a plug body disposed at its other end. The electrical connector casing encloses the whole PCB module, the whole television signal receiving module, the end of the antenna module in order to expose the antenna unit, and the end of the electrical connector plug in order to expose the plug body.

In order to achieve the above-mentioned aspects, the present invention provides an electrical connector with a television signal receiving function, including: a PCB module, a television signal receiving module, an electrical connector plug, an electrical connector casing and an antenna module. The television signal receiving module is electrically disposed on the PCB module. One end of the electrical connector plug is electrically fixed on the PCB module, and the electrical connector plug has a plug body disposed at its other end. The electrical connector casing encloses the whole PCB module, the whole television signal receiving module and the end of the electrical connector plug in order to expose the plug body. The antenna module is received in the electrical connector casing and electrically connected to the PCB module.

Therefore, only the plug body of the electrical connector plug is exposed outside the electrical connector casing (or only the antenna unit of the antenna module and the plug body of the electrical connector plug both are exposed outside the electrical connector casing), the other elements are enclosed in the electrical connector casing. Hence, the structure of the present invention is simple. In addition, the electrical connector is integrated so that the present invention is light and handy and can be carried around conveniently for user. Therefore, the present invention does not need to be detached and assembled in using or carrying.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objectives and advantages of the present invention will be more readily understood from the following detailed description when read in conjunction with the appended drawings, in which:

FIG. 1A is a perspective, schematic view of an electrical connector with a television signal receiving function according to the first embodiment of the present invention;

FIG. 1B is a function block of an electrical connector with a television signal receiving function according to the first embodiment of the present invention;

FIG. 2A is a perspective, schematic view of an electrical connector with a television signal receiving function according to the second embodiment of the present invention;

FIG. 2B is a function block of an electrical connector with a television signal receiving function according to the second embodiment of the present invention;

FIG. 3A is a top, schematic view of an electrical connector with a television signal receiving function according to the third embodiment of the present invention; and

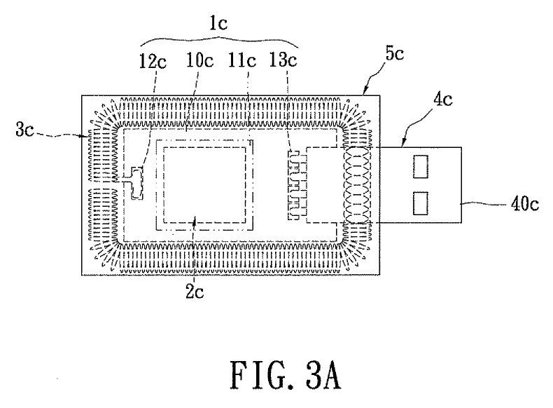

FIG. 3B is a function block of an electrical connector with a television signal receiving function according to the third embodiment of the present invention.

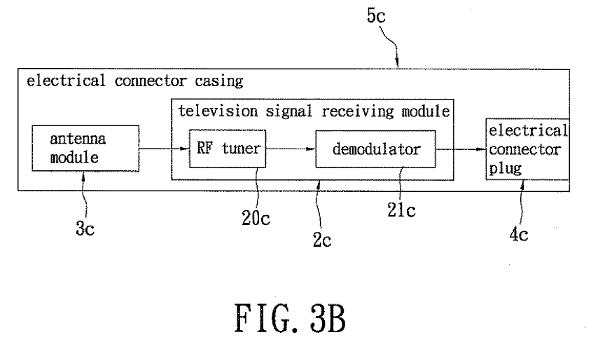

### DETAILED DESCRIPTION OF THE PREFERRED EMBODIMENTS

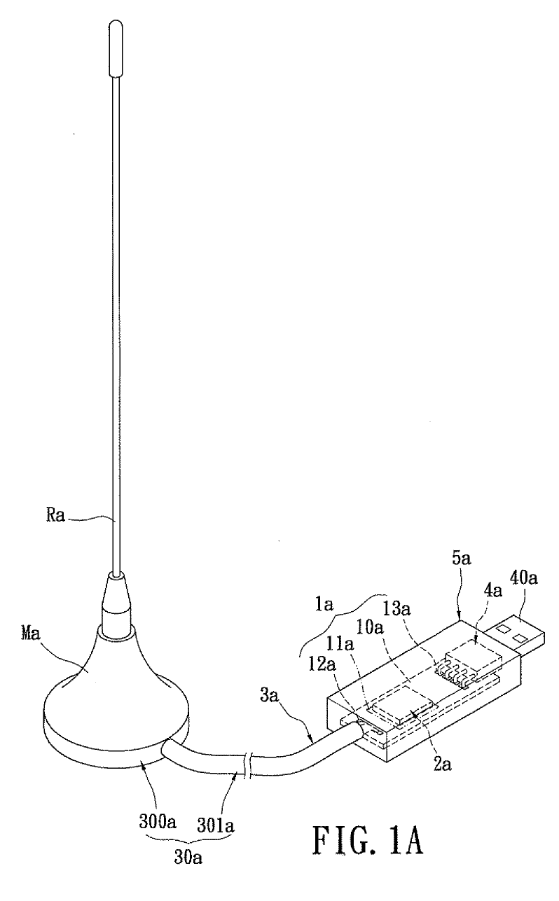

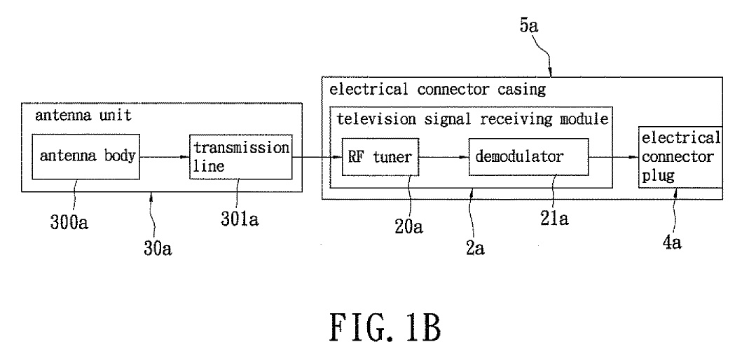

Referring to FIGS. 1A and 1B, the first embodiment of the present invention provides an electrical connector with a television signal receiving function, including: a PCB module 1a, a television signal receiving module 2a, an antenna module 3a, an electrical connector plug 4a and an electrical connector casing 5a.

The PCB module 1a has a PCB substrate 10a, a chip receiving area 11a formed on the PBC body 10a, a first conductive pad 12a disposed on one end of the PCB substrate 10a in order to electrically connect to the antenna module 3a, and a second conductive pad 13a disposed on other end of the PBC body 10a in order to electrically connect to the electrical connector plug 4a.

Moreover, the television signal receiving module 2a is electrically disposed on the PCB module 1a. The television signal receiving module 2a is composed of a RF tuner 20a for transforming broadcast signals into intermediate-frequency signals and a demodulator 21a for demodulating the intermediate-frequency signals in order to output transmission flow signals. In addition, the RF tuner 20a and the demodulator 21a are combined to form a television signal receiving chip, and the television signal receiving chip is electrically disposed on the chip receiving area 11a of the PCB module 1a.

Furthermore, one end of the antenna module 3a is electrically fixed on the PCB module 1a, and the antenna module 3a has an antenna unit 30a disposed at its other end. The antenna unit 30a has an antenna body 300a and a transmission line 310a electrically fixed between the antenna body 300a and the PCB module 1a. The antenna body 300a has a magnetic base Ma for grounding and a signal receiving rod Ra disposed on the magnetic base Ma.

In addition, one end of the electrical connector plug 4a is electrically fixed on the PCB module 1a, and the electrical connector plug 4a has a plug body 40a disposed at its other end. The plug body 40a can be a plug with a USB interface, an IEEE1394 interface or RS232 interface. However, the different types of the plug body 40a are just examples. Any electrical plug is protected in the prevent invention.

Moreover, the electrical connector casing 5a can be an insulative casing. The electrical connector casing 5a encloses the whole PCB module 1a, encloses the whole television signal receiving module 2a, encloses the end of the antenna module 3a in order to expose the antenna unit 30a, and encloses the end of the electrical connector plug 4a in order to expose the plug body 40a. In other words, only the antenna unit 30a of the antenna module 3a and the plug body 40a of the electrical connector plug 4a are exposed outside the electrical connector casing 5a, and other elements such as the PCB module 1a and the television signal receiving module 2a are enclosed by the electrical connector casing 5a. Hence, the structure of the present invention is simple. In addition, the electrical connector is integrated so that the present invention is light and handy and can be carried around conveniently for user. Therefore, the present invention does not need to be detached and assembled in using or carrying.

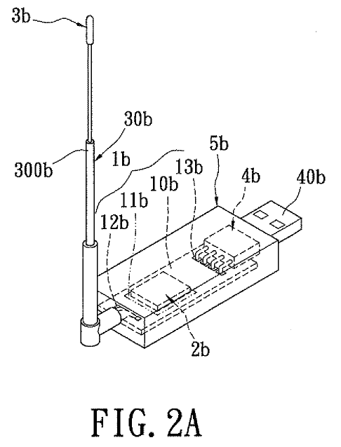

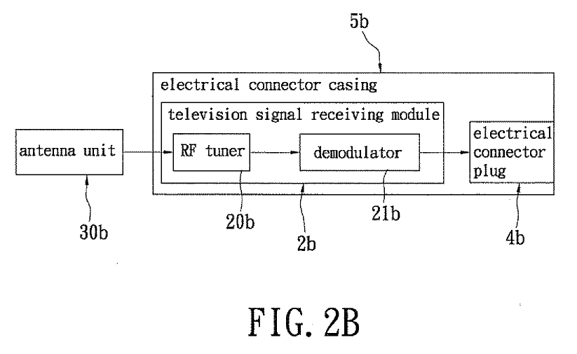

Referring to FIGS. 2A and 2B, the first embodiment of the present invention provides an electrical connector with a television signal receiving function, including: a PCB module 1b, a television signal receiving module 2b, an antenna module 3b, an electrical connector plug 4b and an electrical connector casing 5b.

The PCB module 1b has a PCB substrate 10b, a chip receiving area 11b formed on the PBC body 10b, a first conductive pad 12b disposed on one end of the PCB substrate 10b in order to electrically connect to the antenna module 3b, and a second conductive pad 13b disposed on other end of the PBC body 10b in order to electrically connect to the electrical connector plug 4b. Moreover, the television signal receiving module 2b is electrically disposed on the PCB module 1b. The television signal receiving module 2b is composed of a RF tuner 20b for transforming broadcast signals into intermediate-frequency signals and a demodulator 21b for demodulating the intermediate-frequency signals in order to output transmission flow signals.

Furthermore, one end of the antenna module 3b is electrically fixed on the PCB module 1b, and the antenna module 3b has an antenna unit 30b disposed at its other end. In addition, one end of the electrical connector plug 4b is electrically fixed on the PCB module 1b, and the electrical connector plug 4b has a plug body 40b disposed at its other end. Moreover, the electrical connector casing 5b can be an insulative casing. The electrical connector casing 5b encloses the whole PCB module 1b, encloses the whole television signal receiving module 2b, encloses the end of the antenna module 3b in order to expose the antenna unit 30b, and encloses the end of the electrical connector plug 4b in order to expose the plug body 40b.

Hence, the difference between the second embodiment and the first embodiment is that: in the second embodiment, the antenna unit 30b has an antenna body 300b electrically fixed on the PCB module 1b. In other words, the antenna module 3b of the second embodiment is electrically fixed on the PCB module 1b directly.

Referring to FIGS. 2A and 2B, the first embodiment of the present invention provides an electrical connector with a television signal receiving function, including: a PCB module 1c, a television signal receiving module 2c, an antenna module 3c, an electrical connector plug 4c and an electrical connector casing 5c.

The PCB module 1c has a PCB substrate 10c, a chip receiving area 11c formed on the PBC body 10c, a first conductive pad 12c disposed on one end of the PCB substrate 10c in order to electrically connect to the antenna module 3c, and a second conductive pad 13c disposed on other end of the PBC body 10c in order to electrically connect to the electrical connector plug 4c. Moreover, the television signal receiving module 2c is electrically disposed on the PCB module 1c. The television signal receiving module 2c is composed of a RF tuner 20c for transforming broadcast signals into intermediate-frequency signals and a demodulator 21c for demodulating the intermediate-frequency signals in order to output transmission flow signals.

Furthermore, the antenna module 3c is received in the electrical connector casing 5c and electrically connected to the PCB module 1c. In addition, one end of the electrical connector plug 4c is electrically fixed on the PCB module 1c, and the electrical connector plug 4c has a plug body 40c disposed at its other end. Moreover, the electrical connector casing 5c can be an insulative casing. The electrical connector casing 5c encloses the whole PCB module 1c, encloses the whole television signal receiving module 2c, and encloses the end of the electrical connector plug 4c in order to expose the plug body 40c.

Hence, the difference between the third embodiment and other embodiments is that: in the third embodiment, the antenna module 3c is received in the electrical connector casing 5c and electrically connected to the PCB module 1c. In other words, the whole PCB module 1c, the whole television signal receiving module 2c and the whole antenna module 3c are enclosed by the electrical connector casing 5c, and only the plug body 40c of the electrical connector plug 4c is exposed by the electrical connector casing 5c.

Although the present invention has been described with reference to the preferred best molds thereof, it will be understood that the present invention is not limited to the details thereof. Various substitutions and modifications have been suggested in the foregoing description, and others will occur to those of ordinary skill in the art. Therefore, all such substitutions and modifications are intended to be embraced within the scope of the present invention as defined in the appended claims.

What is claimed is:

1. An electrical connector with a television signal receiving function, comprising:
a PCB module;
a television signal receiving module electrically disposed on the PCB module;
an antenna module, one end of the antenna module electrically fixed on the PCB module, wherein the antenna module has an antenna unit disposed at its other end;
an electrical connector plug, one end of the electrical connector plug electrically fixed on the PCB module, wherein the electrical connector plug has a plug body disposed at its other end; and
an electrical connector casing for enclosing the whole PCB module, enclosing the whole television signal receiving module, enclosing the end of the antenna module in order to expose the antenna unit, and enclosing the end of the electrical connector plug in order to expose the plug body.

2. The electrical connector as claimed in claim 1, wherein the PCB module has a PCB substrate, a clip receiving area formed on the PCB substrate, a first conductive pad disposed on one end of the PCB substrate in order to electrically connect to the antenna module, and a second conductive pad disposed on other end of the PCB substrate in order to electrically connect to the electrical connector plug.

3. The electrical connector as claimed in claim 2, wherein the television signal receiving module is integrated to form a television signal receiving chip, and the television signal receiving chip is electrically disposed on the chip receiving area of the PCB module.

4. The electrical connector as claimed in claim 1, wherein the television signal receiving module is composed of a RF tuner for transforming broadcast signals into intermediate-frequency signals and a demodulator for demodulating the intermediate-frequency signals in order to output transmission flow signals.

5. The electrical connector as claimed in claim 1, wherein the antenna unit has an antenna body and a transmission line electrically fixed between the antenna body and the PCB module.

6. The electrical connector as claimed in claim 5, wherein the antenna body has a magnetic base for grounding and a signal receiving rod disposed on the magnetic base.

7. The electrical connector as claimed in claim 1, wherein the antenna unit has an antenna body electrically fixed on the PCB module.

8. The electrical connector as claimed in claim 1, wherein the plug body is a plug with a USB interface, an IEEE1394 interface or RS232 interface.

9. The electrical connector as claimed in claim 1, wherein the electrical connector casing is an insulative casing.

10. An electrical connector with a television signal receiving function, comprising:
a PCB module;
a television signal receiving module electrically disposed on the PCB module;
an electrical connector plug, one end of the electrical connector plug electrically fixed on the PCB module, wherein the electrical connector plug has a plug body disposed at its other end;
an electrical connector casing for enclosing the whole PCB module, enclosing the whole television signal receiving module, and enclosing the end of the electrical connector plug in order to expose the plug body; and
an antenna module received in the electrical connector casing and electrically connected to the PCB module.

11. The electrical connector as claimed in claim 10, wherein the PCB module has a PCB substrate, a chip receiving area formed on the PCB substrate, a first conductive pad disposed on one end of the PCB substrate in order to electrically connect to the antenna module, and a second conductive pad disposed on other end of the PCB substrate in order to electrically connect to the electrical connector plug.

12. The electrical connector as claimed in claim 11, wherein the television signal receiving module is integrated to form a television signal receiving chip, and the television signal receiving chip is electrically disposed on the chip receiving area of the PCB module.

13. The electrical connector as claimed in claim 11, wherein the television signal receiving module is composed of a RF tuner for transforming broadcast signals into intermediate-frequency signals and a demodulator for demodulating the intermediate-frequency signals in order to output transmission flow signals.

14. The electrical connector as claimed in claim 10, wherein the plug body is a plug with a USB interface, an IEEE1394 interface or RS232 interface.

15. The electrical connector as claimed in claim 10, wherein the electrical connector casing is an insulative casing.
